(19) United States
(12) Patent Application Publication
(10) Pub. No.: US 2017/0354555 A1
(43) Pub. Date: Dec. 14, 2017

(54) HANDLE COVER APPARATUS

(71) Applicant: Hector Biko Amoolo, Belton, MO (US)

(72) Inventor: Hector Biko Amoolo, Belton, MO (US)

(21) Appl. No.: 15/616,851

(22) Filed: Jun. 7, 2017

Related U.S. Application Data
(60) Provisional application No. 62/347,452, filed on Jun. 8, 2016.

(51) Int. Cl. A61G 5/10; B60T 7/10

(52) U.S. Cl. CPC A61G 5/1035; B60T 7/102; A61G 5/1013

(57) ABSTRACT

An improved handle cover apparatus is a handle cover and extension that attaches to the hand brake handle of a wheel chair to provide padding, improved comfort, and greater leverage to allow the brake to be applied more easily and to eliminate the arthritic pain associated with operating the current, short, wheel chair brake handles.

### CROSS-REFERENCE TO RELATED APPLICATION

The present application is related to and claims priority from prior provisional application Ser. No. 62/347,452, filed Jun. 8, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of lever devices and more specifically relates to improved handle cover apparatus.

### 2. Description of the Related Art

Many of the residents in assisted living and senior car facilities have difficulties using the handbrakes on their wheelchairs. Many had arthritis in their hands, and their palms hurt when they must exert pressure on the small brake handle. The rubber cover on the brake handle wears off or slips off easily, leaving just hard metal exposed. Many residents wrapped their handles with layers of duct tape or cloth to provide some protective padding. When the rubber covers come off, they get kicked around and lost, and the pressure of the bare metal against their palms and thumbs makes it extremely painful to use the brakes. The pain that occurs after periods of increased joint use, such as gripping and grasping the metal handles is intense and aggravates their arthritis.

Sometimes users chip their thumbnails or bend them, which causes a different kind of pain. They must do this so many times, every day of their lives, and end up developing visible swelling in the thumb joint over time. In the USA alone, it is estimated there are more than 1.6 million residents in registered nursing-home beds. Of this number, 3% or 48,000 residents are developing arthritis, and 19% or 304,000 already have arthritis, with many more still living at home. These are the same people who depend on wheelchairs for their mobility, and their handbrakes need to be more comfortable to use, so their mobility is not limited because of their inability to apply the brakes. Therefore, a need exists for a specially designed new wheelchair accessory, which will ensure users greater comfort when using the hand brakes on their wheelchairs.

None of the previous art or patents, taken either singly or in combination, is seen to describe the invention as claimed. Ideally, a lever device should provide improved leverage and grip comfort, and yet, would operate reliably and be manufactured at a modest expense. Thus, a need exists for a reliable improved handle cover apparatus to avoid the above-mentioned problems.

### BRIEF SUMMARY OF THE INVENTION

In view of the foregoing disadvantages inherent in the known lever device art, the present invention provides a novel improved handle cover apparatus. The general purpose of the present invention, which will be described subsequently in greater detail, is to provide a improved leverage and grip comfort.

The improved handle cover apparatus for use upon brake handle members may comprise an elongated main body including an outer surface, an inner surface that surrounds and defines an interior volume, a plurality of adaptor members each including an outer surface adapted to frictionally and removably engage the inner surface of the elongated main body, an inner surface that surrounds and defines the interior volume that is adapted to slide over to releasably and frictionally fit upon a wheelchair brake handle, and each of the adaptor members are sized and shaped to be frictionally and removably placed within the interior volume of the elongated main body.

The cross-section of the interior volume of each adaptor member is formed having a shape different from the other adaptor members such that an adaptor member can be chosen from the plurality of adaptor members that is most similar to the cross-section of the brake handle member it is to be placed upon. The cross-sections of the interior volume of the plurality of adaptor members are chosen from a group of cross-sectional shapes consisting of square, rectangular, and circular. The group of cross-sections of the interior volume of the plurality of adaptor members includes hexagonal.

The elongated main body is formed from acetal. The elongated main body is formed from a thermoplastic elastomer. The elongated main body further includes an elongated finger grip member attached to the outer surface thereof that includes a plurality of finger ridges thereon and is adapted and shaped to allow a user to more easily and securely grip the improved handle cover apparatus. The elongated main body is formed from acetal, and the elongated finger grip member is formed from a thermoplastic elastomer. The elongated main body further includes an elongated palm grip member attached to the outer surface on the opposite side from the finger grip member and is formed from a thermoplastic elastomer, and is adapted to allow a user to more easily and securely grip the improved handle cover apparatus. The elongated main body is formed having a curved shape along its length to thereby further allow a user to more easily and securely grip the improved handle cover apparatus.

The improved wheelchair apparatus preferably comprises a wheelchair including a brake handle member having a cross-sectional shape, and an improved handle cover apparatus for use upon the brake handle member comprising an elongated main body including an outer surface, an inner surface surrounding and defining an interior volume, a plurality of adaptor members each including an outer surface adapted to frictionally and removably engage the inner surface of the elongated main body, an inner surface that surrounds and defines the interior volume and is adapted to slide over and releasably and frictionally fit upon the wheelchair brake handle. Each of the adaptor members are sized and shaped to be frictionally and removably placed within the interior volume of the elongated main body.

A cross-section of the interior volume of each respective adaptor member is formed having a shape different from the other adaptor members such that an adaptor member can be chosen from the plurality of adaptor members that is most similar to the cross-section of the brake handle member. The cross-sections of the interior volume of the plurality of adaptor members are chosen from a group of cross-sectional shapes consisting of square, rectangular, circular, and hexagonal. The elongated main body may be formed from acetal or from a thermoplastic elastomer. The elongated main body further may include an elongated finger grip member attached to the outer surface thereof that includes a plurality of finger ridges that is adapted and shaped to allow a user to more easily and securely grip the improved handle cover apparatus.

The elongated main body may be formed from acetal or from a thermoplastic elastomer. The elongated main body further may include an elongated palm grip member attached to the outer surface thereof on an opposite side from the finger grip member that may be formed from a thermoplastic elastomer and adapted to allow a user to more easily and securely grip the improved handle cover apparatus. The elongated main body is formed having a curved shape along its elongated length to thereby further allow a user to more easily and securely grip the improved handle cover apparatus.

The present invention holds significant improvements and serves as an improved handle cover apparatus. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved handle cover apparatus, constructed and operative according to the teachings of the present invention.

FIG. 1 shows a perspective view illustrating an improved handle cover apparatus according to an embodiment of the present invention.

FIG. 2 is a perspective view illustrating the improved handle cover apparatus according to an embodiment of the present invention of FIG. 1.

FIG. 3 is a perspective view illustrating the improved handle cover apparatus according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a lever device and more particularly to a improved handle cover apparatus as used to improve leverage and grip comfort.

Generally speaking, an improved handle cover apparatus is a handle cover and extension that attaches to the hand brake handle of a wheel chair to provide padding, improved comfort, and greater leverage to allow the brake to be applied more easily and to eliminate the arthritic pain associated with operating the current, short, wheel chair brake handles.

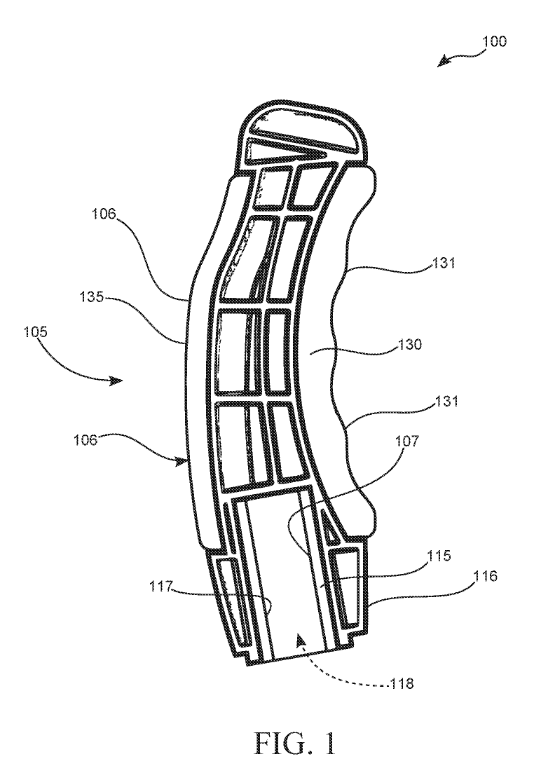

In greater detail now, referring to the drawings by numerals of reference there is shown in FIG. 1, a perspective view illustrating improved handle cover apparatus 100 according to an embodiment of the present invention.

Improved handle cover apparatus 100 for use upon brake handle member 145 may comprise elongated main body 105 including outer surface 106, inner surface 107 that surrounds and defines interior volume 108, a plurality of adaptor member 115 each including outer surface 116 adapted to frictionally and removably engage inner surface 107 of elongated main body 105, inner surface 107 that surrounds and defines interior volume 108 that is adapted to slide over to releasably and frictionally fit upon wheelchair brake handle 125, and each of adaptor member 115 are sized and shaped to be frictionally and removably placed within interior volume 108 of elongated main body 105.

The cross-section of interior volume 108 of each adaptor member 115 is formed having a shape different from the other adaptor members 115 such that each adaptor member 115 can be chosen from the plurality of adaptor member 115 that is most similar to the cross-section of brake handle member 145 it is to be placed upon. The cross-sections of interior volume 118 of the plurality of adaptor members 115 are chosen from a group of cross-sectional shapes consisting of square, rectangular, and circular. The group of cross-sections of the interior volume of the plurality of adaptor members 115 includes hexagonal.

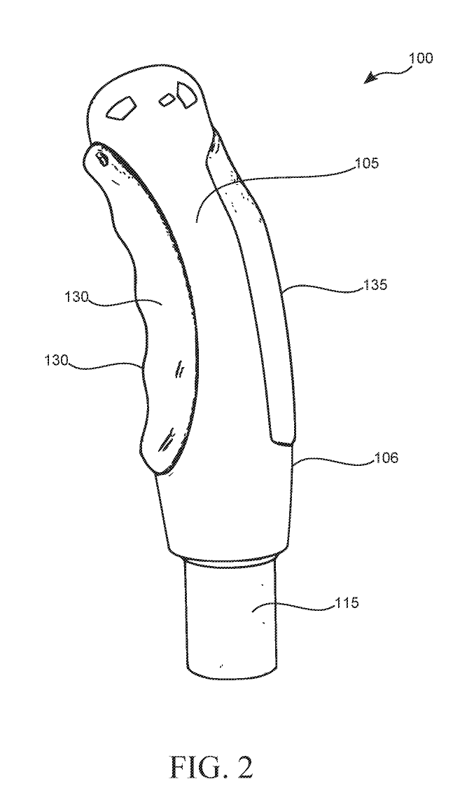

Referring now to FIG. 2, is a perspective view illustrating improved handle cover apparatus 100 according to an embodiment of the present invention of FIG. 1.

Elongated main body 105 is formed from acetal. Elongated main body 105 is formed from a thermoplastic elastomer. Elongated main body 105 further includes an elongated finger grip member 130 attached to outer surface 106 thereof that includes a plurality of finger ridges 131 thereon and is adapted and shaped to allow a user to more easily and securely grip improved handle cover apparatus 100. Elongated main body 105 is formed from acetal, and elongated finger grip member 130 is formed from a thermoplastic elastomer. Elongated main body 105 further includes elongated palm grip member 135 attached to outer surface 106 on the opposite side from elongated finger grip member 130 and is formed from a thermoplastic elastomer, and is adapted to allow a user to more easily and securely grip improved handle cover apparatus 100. Elongated main body 105 is formed having a curved shape along its length to thereby further allow a user to more easily and securely grip improved handle cover apparatus 100.

The invention may comprise an improved wheelchair apparatus 101 having a wheelchair 140 including brake handle member 145 having a cross-sectional shape, and improved handle cover apparatus 100 for use upon brake handle member 145 comprising elongated main body 105 including outer surface 106, inner surface 107 surrounding and defining interior volume 118, a plurality of adaptor members 115 each including outer surface 116 adapted to frictionally and removably engage inner surface 107 of elongated main body 105, inner surface 107 that surrounds and defines interior volume 108 that is adapted to slide over and releasably and frictionally fit upon wheelchair brake handle 125. Each of adaptor member 115 are sized and shaped to be frictionally and removably placed within interior volume 118 of elongated main body 105.

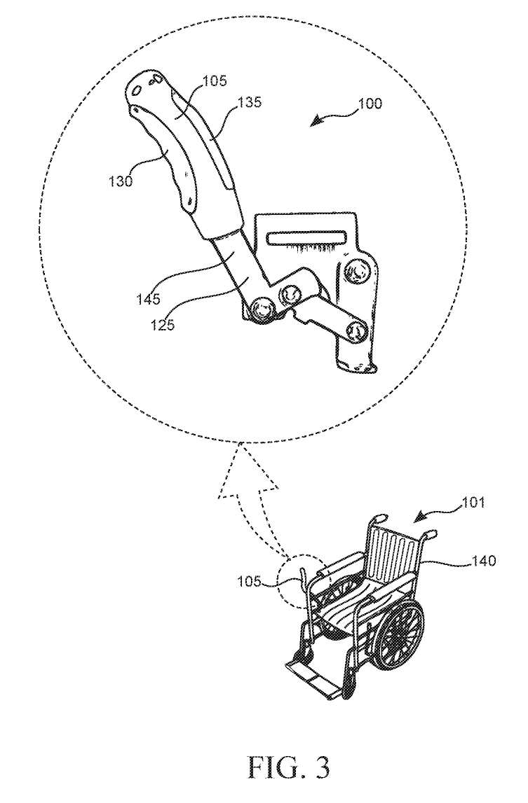

Referring now to FIG. 3, is a perspective view illustrating improved handle cover apparatus 100 according to an embodiment of the present invention of FIG. 1.

A cross-section of interior volume 118 of each respective adaptor member 115 is formed having a shape different from the other adaptor members 115 such that adaptor member 115 can be chosen from the plurality of adaptor members 115 that is most similar to the cross-section of brake handle member 145. The cross-sections of interior volume 118 of the plurality of adaptor member 115 are chosen from a group of cross-sectional shapes consisting of square, rectangular, circular, and hexagonal. Elongated main body 105 may be formed from acetal or from a thermoplastic elastomer. Elongated main body 105 further may include elongated finger grip member 130 attached to outer surface 116 thereof that includes a plurality of finger ridges 131 that is adapted and shaped to allow a user to more easily and securely grip improved handle cover apparatus 100.

Elongated main body 105 may be formed from acetal or from a thermoplastic elastomer. Elongated main body 105 further may include elongated palm grip member 135 attached to outer surface 106 thereof on an opposite side from elongated finger grip member 130 that may be formed from a thermoplastic elastomer and adapted to allow a user to more easily and securely grip improved handle cover apparatus 100. Elongated main body 105 is formed having a curved shape along its elongated length to thereby further allow a user to more easily and securely grip improved handle cover apparatus 100.

Improved handle cover apparatus 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other package contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the u.s. patent and trademark office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved handle cover apparatus for use upon brake handle members, comprising:
an elongated main body including;
an outer surface;
an inner surface;
wherein said inner surface surrounds and defines an interior volume;
a plurality of adaptor members, each including;
an outer surface;
wherein said outer surface is adapted to frictionally and removably engage said inner surface of said elongated main body;
an inner surface;
wherein said inner surface surrounds and defines an interior volume and is adapted to slide over and releasably and frictionally fit upon a wheelchair brake handle; and
wherein each of said plurality of adaptor members are sized and shaped to be frictionally and removably placed within said interior volume of said elongated main body; and
wherein a cross-section of said interior volume of each respective said plurality of adaptor members is formed having a shape different from the other of said plurality of adaptor members, such that an adaptor member can be chosen from said plurality of adaptor members that is most similar to a cross-section of a brake handle member it is to be placed upon.

2. The improved handle cover apparatus of claim 1, wherein said cross-sections of said interior volume of said plurality of adaptor members are chosen from a group of cross-sectional shapes consisting of square, rectangular, and circular.

3. The improved handle cover apparatus of claim 2, wherein said group of cross-sections of said interior volume of said plurality of adaptor members includes hexagonal.

4. The improved handle cover apparatus of claim 1, wherein said elongated main body is formed from acetal.

5. The improved handle cover apparatus of claim 1, wherein said elongated main body is formed from a thermoplastic elastomer.

6. The improved handle cover apparatus of claim 1, wherein said elongated main body further includes an elongated finger grip member attached to said outer surface thereof and includes a plurality of finger ridges thereon, and is adapted and shaped to allow a user to more easily and securely grip said improved handle cover apparatus.

7. The improved handle cover apparatus of claim 6, wherein said elongated main body is formed from acetal; and wherein said elongated finger grip member is formed from a thermoplastic elastomer.

8. The improved handle cover apparatus of claim 6, wherein said elongated main body further includes an elongated palm grip member attached to said outer surface thereof an opposite side from said finger grip member, is formed from a thermoplastic elastomer, and is adapted to allow a user to more easily and securely grip said improved handle cover apparatus.

9. The improved handle cover apparatus of claim 6, wherein said elongated main body is formed having a curved shape along its elongated length to thereby further allow a user to more easily and securely grip said improved handle cover apparatus.

10. An improved wheelchair apparatus comprising:
a wheelchair including:
a brake handle member;
wherein said brake handle member has a cross-sectional shape; and
an improved handle cover apparatus for use upon said brake handle member, comprising:
an elongated main body including;
an outer surface;
an inner surface;
wherein said inner surface surrounds and defines an interior volume;
a plurality of adaptor members, each including;
an outer surface;
wherein said outer surface is adapted to frictionally and removably engage said inner surface of said elongated main body;
an inner surface;
wherein said inner surface surrounds and defines an interior volume and is adapted to slide over and releasably and frictionally fit upon said wheelchair brake handle; and
wherein each of said plurality of adaptor members are sized and shaped to be frictionally and removably placed within said interior volume of said elongated main body; and
wherein a cross-section of said interior volume of each respective said plurality of adaptor members is formed having a shape different from the other of said plurality of adaptor members, such that an adaptor member can be chosen from said plurality of adaptor members that is most similar to said cross-section of said brake handle member.

11. The improved wheelchair apparatus of claim 10, wherein said cross-sections of said interior volume of said plurality of adaptor members are chosen from a group of cross-sectional shapes consisting of square, rectangular, and circular.

12. The improved wheelchair apparatus of claim 11, wherein said group of cross-sections of said interior volume of said plurality of adaptor members includes hexagonal.

13. The improved wheelchair apparatus of claim 10, wherein said elongated main body is formed from acetal.

14. The improved wheelchair apparatus of claim 10, wherein said elongated main body is formed from a thermoplastic elastomer.

15. The improved wheelchair apparatus of claim 10, wherein said elongated main body further includes an elongated finger grip member attached to said outer surface thereof and includes a plurality of finger ridges thereon, and is adapted and shaped to allow a user to more easily and securely grip said improved handle cover apparatus.

16. The improved wheelchair apparatus of claim 15, wherein said elongated main body is formed from acetal; and wherein said elongated finger grip member is formed from a thermoplastic elastomer.

17. The improved wheelchair apparatus of claim 15, wherein said elongated main body further includes an elongated palm grip member attached to said outer surface thereof an opposite side from said finger grip member, is formed from a thermoplastic elastomer, and is adapted to allow a user to more easily and securely grip said improved handle cover apparatus.

18. The improved wheelchair apparatus of claim 15, wherein said elongated main body is formed having a curved shape along its elongated length to thereby further allow a user to more easily and securely grip said improved handle cover apparatus.
